(19) United States
(12) Patent Application Publication
(10) Pub. No.: US 2006/0227082 A1
(43) Pub. Date: Oct. 12, 2006

(54) Semiconductor intergrated circuit for display driving and electronic device having light emitting display

(75) Inventors: Yasuhiro Ogata, Tokyo (JP); Takayuki Keicho, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/397,684

(22) Filed: Apr. 5, 2006

(30) Foreign Application Priority Data
Apr. 6, 2005 (JP) 2005-109708

(51) Int. Cl. G09G 3/30

(52) U.S. Cl. 345/76

(57) ABSTRACT

The present invention provides a semiconductor integrated circuit for driving a light emitting panel such as an organic EL panel capable of displaying a picture with the optimum picture quality by changing a gray scale voltage and a gamma curve characteristic in accordance with brightness of the environment and specifications of a display used. A semiconductor integrated circuit for display driving is provided with a storing circuit such as a register or a ROM for storing a plurality of values for changing the amplitude of a gray scale voltage, and a storing circuit such as a register or a ROM for storing a plurality of values for changing the gamma curve characteristic. By selecting a value from a plurality of values in the storing circuit in accordance with an output of a photosensor and supplying the selected value to a gray scale voltage generation circuit, the gray scale voltage and the gamma curve characteristic can be dynamically changed.

### CROSS-REFERENCE TO RELATED APPLICATION

The present application claims priority from Japanese patent application No 2005-109708 filed on Apr. 6, 2005, the content of which is hereby incorporated by reference into this application.

### BACKGROUND OF THE INVENTION

The present invention relates to a light emitting display driving apparatus for generating a gray scale voltage according to display data and outputting the gray scale voltage to a light emitting panel such as an organic EL panel and, more particularly, to a technique effectively applied to a semiconductor integrated circuit for driving a light emitting display such as an organic EL display whose gamma characteristic (the gray scale number-luminance characteristic) can be adjusted, and an electronic device having the same.

In recent years, as a display of a portable electronic device such as a cellular phone, a digital camera, or PDAs (Personal Digital Assistants), a light emitting panel such as an organic EL panel in which a plurality of display pixels are arranged two-dimensionally in matrix or a liquid crystal display panel using backlight is used. A device on which such a display panel is mounted has therein a driver taking the form of a semiconductor integrated circuit for driving the panel.

The specifications such as a gamma characteristic, a drive voltage (gray scale voltage), and the frequency of an operation clock of the driver for an organic EL panel or a liquid crystal display panel vary according to the kind and a driving method of a panel used. Manufacturers providing display drivers enable a gamma characteristic and a gray scale voltage to be adjusted so that the drivers can be applied to display panels of different specifications. An invention related to a circuit capable of adjusting a gamma characteristic and a gray scale voltage to desirable gamma characteristic and gray scale voltage in accordance with the characteristics of an organic EL panel is disclosed in, for example, Japanese Unexamined Patent Publication No. 2004-354625.

In the earlier application, attention is paid to the fact that variations of the gamma characteristics of R, G, and B colors are different from each other in a light emitting display such as an organic EL panel. By providing a register for selecting voltages at both ends of gray scale voltages adjusted to characteristic variations and a register for selecting a gamma curve for each of the colors of R, G, and B and setting register values in accordance with the characteristic variations, the gray scale voltage and the gamma characteristic can be adjusted.

Since the organic EL panel is a light emitting display, it has a drawback such that a picture displayed is not always seen well depending on the brightness of the environment of the device although brightness is the same. To address the issue, an invention of providing a photosensitive element that detects the brightness of the environment and changing the luminance of an organic EL device in accordance with the brightness of the environment has been proposed (Japanese Unexamined Patent Publication No. 2004-325748).

The invention of changing the luminance of an organic EL device in accordance with the brightness of the environment, however, does not adjust a gamma characteristic in accordance with the brightness of the environment and does not disclose a concrete mechanism of changing the luminance of the organic EL device.

An object of the present invention is to provide a semiconductor integrated circuit for driving a light emitting panel such as an organic EL panel capable of displaying an image which can be seen well in any environment by automatically changing the luminance in accordance with the brightness of the environment.

Another object of the present invention is to provide a semiconductor integrated circuit for driving a light emitting panel such as an organic EL panel capable of displaying an image with optimum picture quality by changing a gray scale voltage and a gamma curve characteristic in accordance with the brightness of the environment and the specifications of a display used.

The above and other objects and novel features of the present invention will become apparent from the following description of the specification and the appended drawings.

### SUMMARY OF THE INVENTION

An outline of representative one of inventions disclosed in the application will be described as follows.

A semiconductor integrated circuit for display driving is provided with a storing circuit such as a register or a ROM for storing a plurality of values for changing the amplitude of a gray scale voltage, and a storing circuit such as a register or a ROM for storing a plurality of values for changing the gamma curve characteristic. By selecting a value from a plurality of values in the storing circuit in accordance with an output of a photosensor and supplying the selected value to a gray scale voltage generation circuit, the gray scale voltage and the gamma curve characteristic can be dynamically changed.

With the means, the luminance is automatically changed according to the brightness of the environment, so that a picture can be displayed in a visible manner on a light emitting panel under any environment. Desirably, an A/D converter for converting an output of the photosensor to a digital signal is provided, and a comparator as a component of the A/D converter has a hysteresis characteristic. Further, a timing adjustment circuit for adjusting a timing of determining an output of the photosensor is provided. With the configuration, the circuit is prevented from sensitively reacting to a change in brightness of the environment, so that the luminance of display does not change frequently, and viewability does not deteriorate.

Effects obtained by the representative one of the inventions disclosed in the application will be briefly described as follows.

According to the present invention, a semiconductor integrated circuit for driving a light emitting panel such as an organic EL panel capable of displaying an image which can be seen well in any environment by automatically changing the luminance in accordance with the brightness of the environment can be realized.

According to the present invention, a semiconductor integrated circuit for driving a light emitting panel such as an organic EL panel capable of displaying an image with optimum picture quality by changing a gray scale voltage and a gamma curve characteristic in accordance with the brightness of the environment and the specifications of a display used can be realized.

### BRIEF DESCRIPTION OF THE DRAWINGS

FIG. 1 is a block diagram showing an example of the configuration of an organic EL display constructed by an organic EL panel driver IC having therein a signal line drive circuit for an organic EL panel to which the present invention is effectively applied, and an organic EL panel driven by the driver IC.

FIGS. 2A and 2B are characteristic diagrams illustrating characteristic variations among R, G, and B of organic EL elements according to the present invention, in which FIG. 2A is a diagram showing V-I characteristic variations among R, G, and B, and FIG. 2B is a diagram showing I-B characteristic variations among R, G, and B.

FIGS. 3A and 3B are diagrams showing gamma characteristic adjustment according to the invention, in which FIG. 3A is a diagram showing gray scale voltage amplitude adjustment, and FIG. 3B is a diagram showing gray scale voltage curve adjustment.

FIG. 4 is a circuit configuration diagram showing a concrete example of a gray scale voltage generation circuit in a signal line drive circuit in an organic EL panel driver IC according to the invention.

FIG. 5 is a circuit configuration diagram showing a concrete example of an automatic light control circuit and a control register in the organic EL panel driver IC according to the invention.

FIG. 6 is a circuit configuration diagram showing a first embodiment of an A/D converter as a component of the automatic light control circuit.

FIG. 7 is a circuit configuration diagram showing a second embodiment of the A/D converter as a component of the automatic light control circuit.

FIG. 8 is a characteristic diagram showing a hysteresis characteristic of a comparator in an A/D converter of a second embodiment.

FIG. 9 is a block diagram showing an example of the configuration of an organic EL panel driver IC having therein a signal line drive circuit of an organic EL panel to which the present invention is effectively applied.

### DETAILED DESCRIPTION OF THE PREFERRED EMBODIMENTS

Preferred embodiments of the present invention will be described hereinbelow with reference to the drawings.

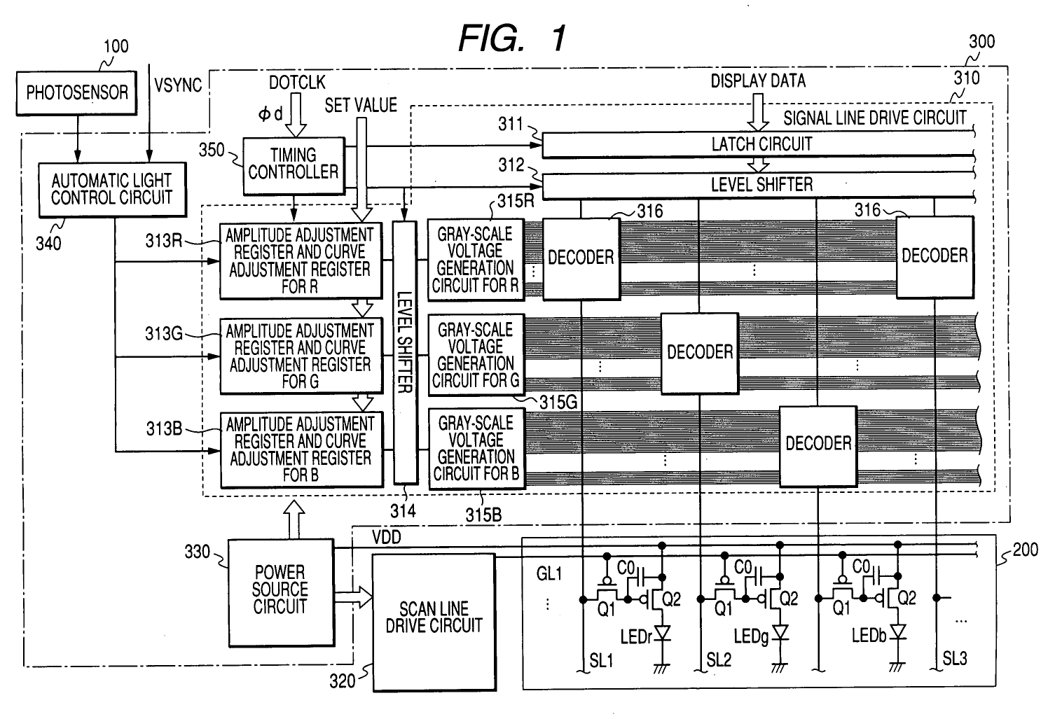

FIG. 1 shows the configuration of an organic EL display including a semiconductor integrated circuit for driving an organic EL panel (organic EL panel driver IC) having therein a signal line drive circuit for an organic EL panel to which the present invention is effectively applied, and an organic EL panel driven by the driver IC. In FIG. 1, 200 denotes an organic EL panel in which organic EL elements are arranged in matrix, and 300 denotes an organic EL panel driver IC for driving the organic EL panel 200 to display a picture.

In the organic EL panel 300, source lines (source electrodes) SL1, SL2, . . . as a plurality of signal lines to which an image signal is applied and gate lines (gate electrodes) GL1, . . . as a plurality of scan lines sequentially selectively driven in predetermined cycles are disposed in directions orthogonal to each other. Pixels are disposed at intersecting points of the source lines SL1, SL2, . . . and the gate lines GL1, . . . . The organic EL panel 300 is constructed as active matrix panel. Each pixel is constructed by a TFT (Thin Film Transistor) Q1 as a selection element whose gate terminal is connected to any of the scan lines GL and whose source terminal is connected to any of the signal lines SL, a TFT Q2 as a switching element, and an organic EL element LED as a light emitting element connected to the TFT Q2 in series between a power supply line VDL and a ground point. The TFT Q2 has a gate terminal connected to the drain terminal of the selection TFT Q1, and a source terminal connected to a power supply line VDL for supplying a power supply voltage VDD.

The organic EL elements LED include an element LEDR for R (red), an element LEDg for G (green), and an element LEDb for B (blue). The pixels having the elements are arranged in order of R, G, and B. In addition, a capacitive element C0 for holding an image signal supplied via a signal line SL also while the selection TFT Q1 is off is provided between the gate terminal and the source terminal of the switching TFT Q2. According to a gray scale voltage applied to the gate terminal of the TFT Q2 via the selection TFT Q1, the amount of current flowing in the organic EL elements LEDr, LEDg, and LEDb changes, thereby controlling luminance of each pixel.

The organic EL panel driver IC 300 has a signal line drive circuit 310 for driving the signal lines SL1, SL2, . . . of the organic EL panel 200 and a power source circuit 330 for supplying a voltage necessary for the drive circuit. The driver IC 300 also has an automatic light control circuit 340 for generating a control signal to be sent to the signal line drive circuit 310 on the basis of a signal from an external photosensor 100 and a vertical sync signal VSYNC, and a timing controller 350 for generating an operation timing signal of a circuit in the chip 320 denotes a scan line drive circuit for driving the scan lines GL1, . . . of the organic EL panel 200, and the power source circuit 330 also generates a voltage necessary for the scan line drive circuit 320.

The signal line drive circuit 310 controls the gray scale voltage of an image signal applied to the signal lines SL1, SL2, . . . of the organic EL panel 300 on the basis of display data transferred from the CPU. The signal line drive circuit 310 includes a latch circuit 311 for latching display data, a level shifter 312 for shifting the level of a display data signal, control registers 313, a level shifter 314 for shifting the level of an output signal of the control register 313, gray scale voltage generating circuits 315, and decoders 316. The gray scale voltage generation circuit 315 generates a plurality of gray scale voltages necessary for the gray scale voltage control of the signal lines SL1, SL2, . . . of the organic EL panel 200. The decoder 316 selects one of the plurality of gray scale voltages in accordance with display data. The latch circuit 311, the control register 313, and the level shifters 312 and 314 are controlled by operation timing signals generated by the timing controller 350.

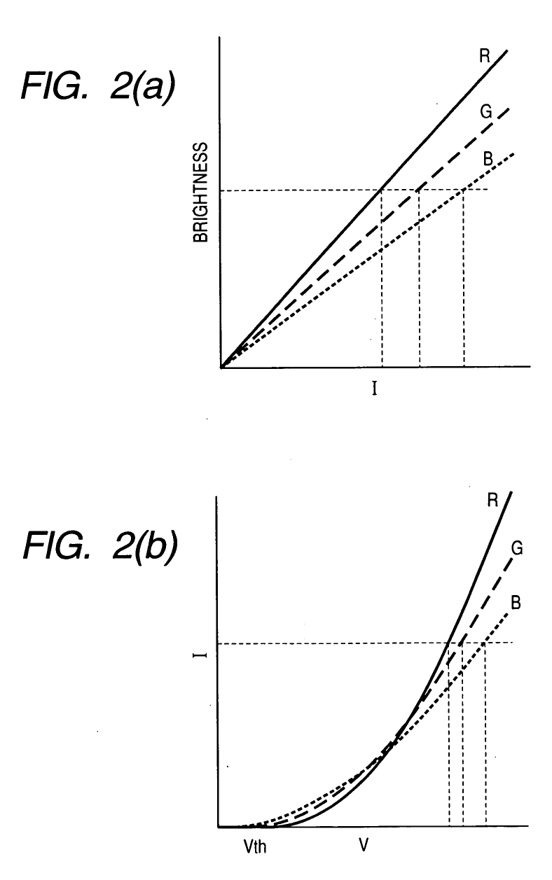

The control registers 313 and the gray scale voltage generation circuits 315 include a control register 313R and a gray scale voltage generation circuit 315R for R, a control register 315G and a gray scale voltage generation circuit 315G for G, and a control register 313B and a gray scale voltage generation circuit 315B for B. Each of the control registers 313R, 313G, and 313B includes two kinds of registers; an amplitude adjustment register that stores values designating the maximum and minimum gray scale voltages, and a curve adjustment register that stores a value designating the characteristic of a gamma curve for corresponding color for the following reason. The organic EL elements of pixels of R, G, and B have different I-B (current-brightness) characteristics each indicative of the relation between the current flowed in the element and the brightness as shown in FIG. 2A, and have different V-I (voltage-current) characteristics each indicative of the relation between a voltage applied to the element and a current flowing in the element as shown in FIG. 2B.

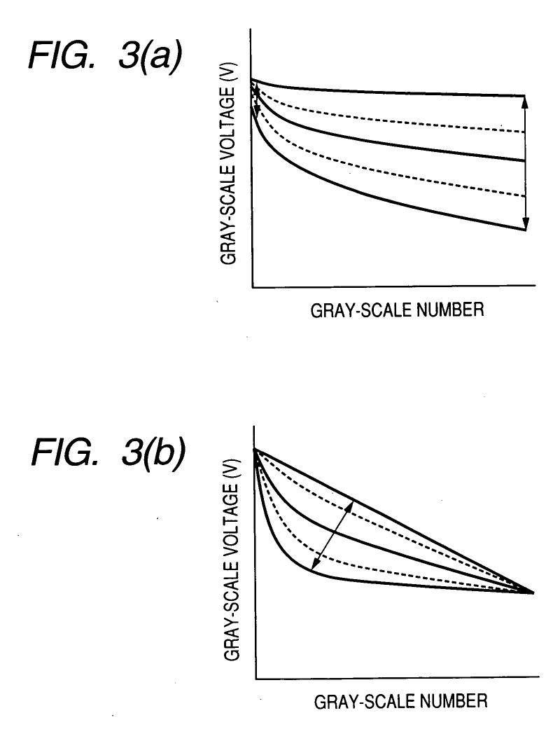

The amplitude adjustment register stores a value for changing the characteristic of the gray scale voltage in accordance with the characteristic of an organic EL element in an organic EL panel used as shown in FIG. 3A. On the other hand, the curve adjustment register stores a value for changing the characteristic of the gamma curve in accordance with the characteristics of an organic EL element in the organic EL panel used as shown in FIG. 3B. In the embodiment, the characteristic of the gray scale voltage and the characteristic of the gamma curve can be set for each of the colors R, G, and B.

The timing controller 350 has a counter for counting a clock, counts a dot clock φd received from the outside, and generates a line clock φl. The latch circuit 311 sequentially latches display data in unit such as 18 bits synchronously with the dot clock φd, operates at the timing of the trailing edge of the line clock φl, and transfers a line of display data to the level shifter 312.

The level shifter 312 shifts the display data transferred from the latch circuit 311 from the Vcc-GND level of a power supply voltage of the logic circuit to the VDD-VSS level of an operation power supply of the gray scale voltage generation circuits 315R, 315G, and 315B and the decoder circuit 313. The level shifting is performed for the reason that the blocks have to be controlled at the voltage levels according to the operation power supplies of the blocks.

The control registers 313R, 313G, and 313B for the R, G, and B colors, respectively, have therein latch circuits, latch register set values supplied from an external CPU at power-on or the like, and transfer the register set values to the level shifter 314 at the timing of the trailing edge of the line clock φl from the timing controller 350. The level shifter 314 shifts the register set value signals supplied from the control registers 313R, 313G, and 313B from the Vcc-GND level to the VDD-GND level and transfers the resultant signals to the gray scale voltage generation circuits 315R, 315G, and 315B.

The gray scale voltage generation circuits 315R, 315G, and 315B for the R, G, and B colors, respectively, generate a plurality of gray scale voltages in accordance with the register set values supplied via the level shifter 314. The decoder 316 plays the role of a DA converter for converting digital display data to an analog gray scale voltage by selecting a voltage corresponding to a bit code of display data from the level shifter 312 from analog gray scale voltages generated by the gray scale voltage generation circuits 315R, 315G, and 315B.

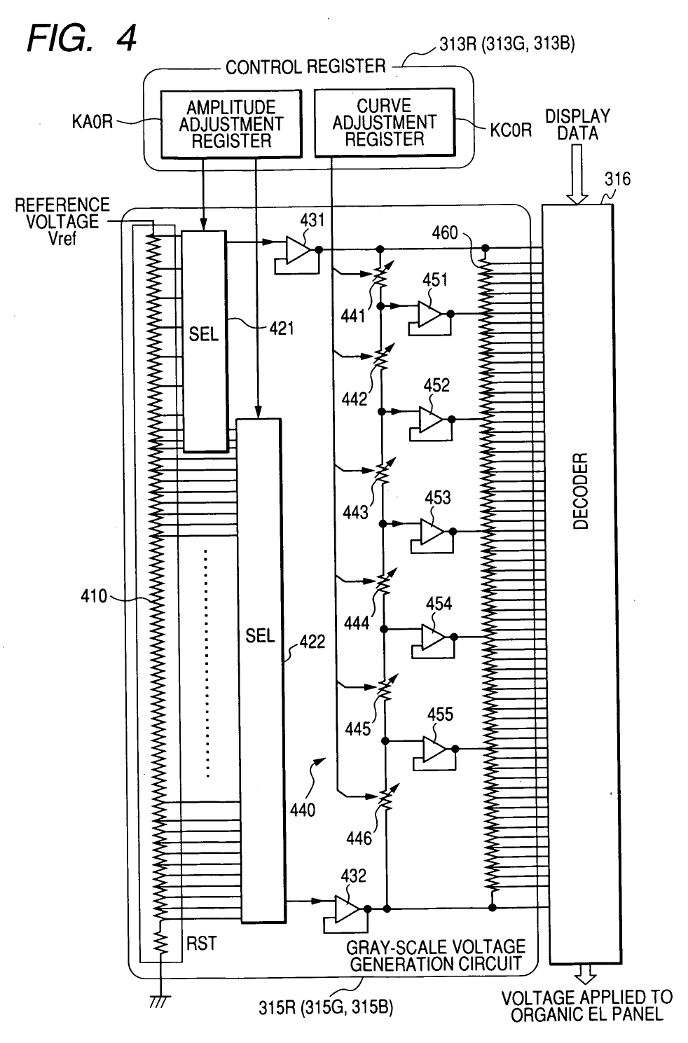

Next, with reference to FIG. 4, concrete configuration and operation of the gray scale voltage generation circuits 315R, 315G, and 315B of R, G, and B according to the invention will be described. Since the gray scale voltage generation circuits 315R, 315G, and 315B have the same configuration, the control register 313R and the gray scale voltage generation circuit 315R for R will be described representatively, and the circuits of the other colors will not be illustrated and described. For convenience of the diagrams, the level shifters 312 and 314 are not shown in FIG. 4.

As shown in FIG. 4, the control register 313R has an amplitude adjustment register KA0R and a curve adjustment register KC0R. The gray scale voltage generation circuit 315R has a resistive divider 410 including a ladder resistor provided between a reference voltage Vref supplied from the outside and a ground point GND, and selectors 421 and 422 for selecting any of a plurality of voltage levels generated by the resistive divider 410 as a gray scale voltage. The gray scale voltage generation circuit 315R also has voltage followers 431 and 432 constructed by operational amplifiers for impedance-converting the voltages selected by the selectors 421 and 422, and a resistive divider 440 constructed by variable resistors 441 to 446 for resistive-dividing output voltages from the voltage followers 431 and 432. Further, the gray scale voltage generation circuit 315R includes voltage followers 451 to 455 constructed by operational amplifiers for impedance-converting the voltages divided by the resistive divider 440, and a resistive divider 460 taking the form of a ladder resistor for resistive-dividing the output voltages of the voltage followers 431 and 432 and the voltage followers 451 to 455, thereby generating gray scale voltages of desired number of shades (for example, 64 shades of gray).

The selector 421 provided on the high voltage side of the selectors 421 and 422 selects a voltage according to the maximum gray scale voltage set value of the amplitude adjustment register KA0R, and the selector 422 provided on the low voltage side selects a voltage according to the minimum gray scale voltage set value of the amplitude adjustment register KA0R. The voltages selected by the selectors 421 and 422 are supplied as gray scale voltages according to the minimum and maximum voltages of the number of shades to the resistive divider 440 via the voltage followers 431 and 432.

The variable resistors 441 to 446 of the resistive divider 440 are constructed so as to be able to change their resistance values on the basis of the set value of the curve adjustment register KC0R. Such a variable resistor is not limited to a device whose resistance value changes in an analog manner in accordance with a voltage such as a MOSFET but may be a resistor including a plurality of series resistors, and a plurality of switching elements provided in parallel with the series resistors, and whose resistance value changes according to the number of switch elements which are turned on.

The gray scale voltage generation circuit 315R of the embodiment has the above-described circuit configuration and generates a gray scale voltage (reference gray scale voltage) as a reference of obtaining a desired gray scale number—gray scale voltage characteristic by resistive division of the variable resistors 441 to 446. Further, the gray scale voltages generated are buffered by the voltage followers 451 to 455 in a post stage and divided by the resistive divider 460 constructed by the ladder resistor so that the gray scale voltages become linear, thereby generating gray scale voltages of 64 shades to which the gray scale number corresponds. The gray scale voltages of 64 shades generated by the gray scale voltage generation circuit 315R are decoded (converted) to gray scale voltages adjusted to display data by the decoder 316, and the resultant is output as a voltage (output voltage) applied to a corresponding signal line in the organic EL panel 200. The other gray scale voltage generation circuits 315G and 315B are similarly constructed.

With the circuit configuration, by setting the amplitude adjustment register KA0R, the curve adjustment register KC0R, and the like in adjustment of the gamma characteristic, the amplitude voltage of the gray scale voltage and the curve of a halftone part can be adjusted. Thus, the gray scale voltage generation circuit achieving high-quality display can be realized.

Next, a configuration example and operation of the automatic light control circuit 340 for adjusting luminance of an organic EL element on the basis of a signal from a photosensor shown in FIG. 1 and the control register 313 will be described.

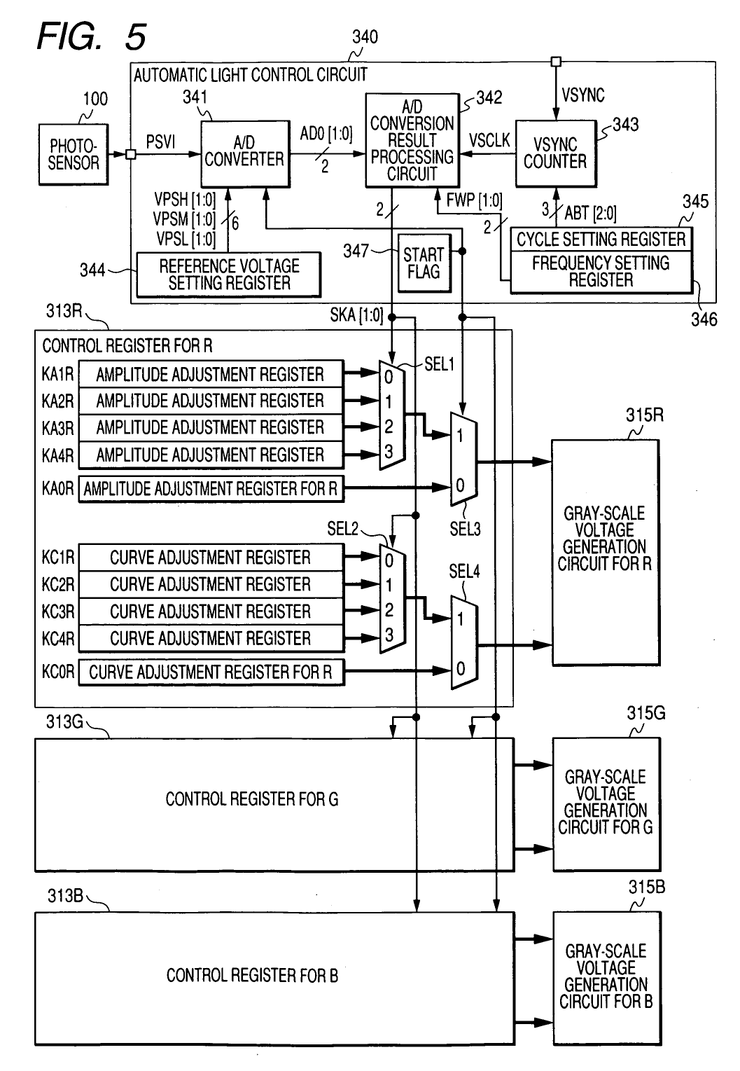

FIG. 5 is a configuration diagram of the automatic light control function for adjusting the gamma characteristic. The automatic light control function of the embodiment is constructed by the automatic light control circuit 340, the control register 313R for R, the gray scale voltage generation circuit 315R for R, the control register 313G for G, the gray scale voltage generation circuit 315G for G, the control register 313B for B, and the gray scale voltage generation circuit 315B for B. The automatic light control circuit 340 has an A/D converter 341 for converting a signal PSVI input from the external photosensor 100 to a digital signal, an A/D conversion result processing circuit 342 for giving a gray scale voltage adjustment timing by supplying the A/D conversion result to the control register 313R for R in set cycles, and a VSYNC counter 343 for generating a cycle signal. The automatic light control circuit 340 also has a reference voltage setting register 344 for setting a reference voltage used in the A/D converter 341, a cycle setting register 345 for setting a cycle of reflecting the A/D conversion result, a frequency setting register 346 for setting the frequency of reflecting the A/D conversion result, and a start setting flag 347 for setting validity/invalidity of the automatic light control function.

The control register 313R for R has, in addition to the inherent amplitude adjustment register KA0R and curve adjustment register KC0R for R shown in FIG. 4, four amplitude adjustment registers KA1R, KA2R, KA3R, and KA4R for automatic light control. The register 313R has a selector SEL1 for selecting one of the four amplitude adjustment registers for automatic light control, and a selector SEL2 for selecting an output of the amplitude adjustment register KA0R for R or any of the amplitude adjustment registers KA1R to KA4R for automatic light control. Further, the register 313R has four curve adjustment registers KC1R, KC2R, KC3R, and KC4R for automatic light control, a selector SEL3 for selecting one of the four curve adjustment registers for automatic light control, and a selector SEL4 for selecting an output of the inherent curve adjustment register KC0R for R or any of the curve adjustment registers KC1R to KC4R for automatic light control. Since each of the control register 313G for G and the control register 313B for B has a circuit configuration similar to that of the control register 313R for R, the control register 313R for R will be described and the detailed configuration of the control register 313G for G and the control register 313B for B will not be illustrated and described.

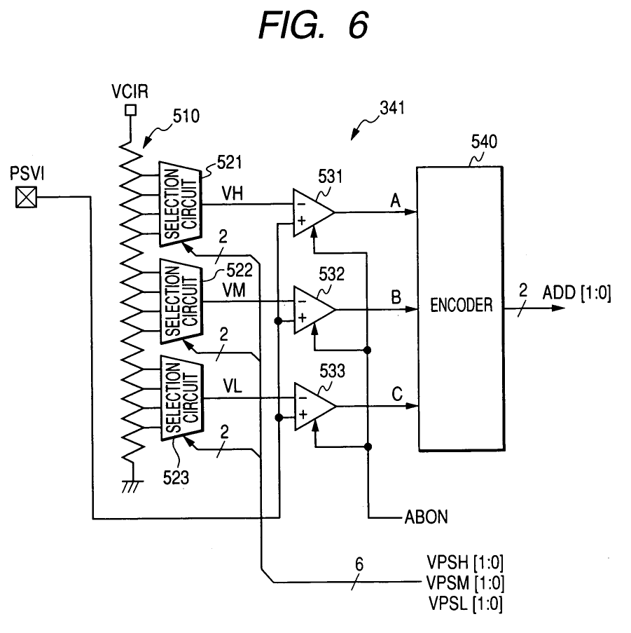

FIG. 6 shows an example of a detailed configuration of the A/D converter 341. The A/D converter 341 of the embodiment has a resistive divider 510 taking the form of a ladder resistor, and selection circuits (selectors) 521, 522, and 523 for selecting proper voltages out of voltages generated by dividing a constant voltage VCIR by the resistive divider 510. The A/D converter 341 also includes comparators 531, 532, and 533 having inversion input terminals to which the voltages selected by the selection circuits (selectors) 521, 522, and 523 are applied and non-inversion input terminals to which the signal PSVI from the external photosensor 100 is input, and an encoder 540 for encoding outputs of the comparators 531, 532, and 533 and outputting the results as 2-bit signals.

The comparators 531, 532, and 533 are made active or inactive according to the state of the start setting flag 347. The selection circuits (selectors) 521, 522, and 523 select proper voltages from voltages generated by the resistive divider 510 in accordance with 2-bit set values VPSH[1:0], VPSM[1:0], and VPSL[1:0] of the reference voltage setting register 344. Tables 1 to 3 show an example the relation between the set values VPSH[1:0], VPSM[1:0], and VPSL[1:0] and reference voltages selected by the selection circuits (selectors) 521, 522, and 523. Table 4 shows the relations of inputs and outputs of the encoder 540, that is, outputs of the comparators 531, 532, and 533, the A/D conversion result ADO[1:0], and the degree of brightness of the environment.

TABLE 1

| Register value | Reference voltage VH[V] |
|---|---|
| VPSH[1:0] | (VCIR = 2.5 V) |
| 00 | VCIR × 0.35 |
| 01 | VCIR × 0.45 |
| 10 | VCIR × 0.55 |
| 11 | VCIR × 0.65 |

TABLE 2

| Register value | Reference voltage VM[V] |
|---|---|
| VPSM[1:0] | (VCIR = 2.5 V) |
| 00 | VCIR × 0.20 |
| 01 | VCIR × 0.25 |
| 10 | VCIR × 0.30 |
| 11 | VCIR × 0.35 |

TABLE 3

| Register value | Reference voltage VL[V] |
|---|---|
| VPSL[1:0] | (VCIR = 2.5 V) |
| 00 | VCIR × 0.05 |
| 01 | VCIR × 0.10 |
| 10 | VCIR × 0.15 |
| 11 | VCIR × 0.20 |

TABLE 4

| | A/D conversion result | |
|---|---|---|
| Inputs A, B, C | ADO[1:0] | Degree of brightness |
| 000 | 00 | The darkest environment |
| 001 | 01 | The second darkest |
| | | environment |
| 011 | 10 | The second brightest |
| | | environment |
| 111 | 11 | The brightest environment |

As shown in Table 4, the case where the inputs A, B, and C=000 is the darkest environment, and ADO[1:0]=00 is output. The case where the inputs A, B, and C=001 indicates the second darkest environment, and ADO[1:0]=01 is output. The case where the inputs A, B, and C=011 indicates the second brightest environment, and ADO[1:0]=10 is output. The case where the inputs A, B, and C=111 indicates the brightest environment, and ADO[1:0]=11 is output. When the signal PSVI from the external photosensor 100 is input to the A/D converter 341, the A/D converter 341 converts the signal PSVI to a 2-bit digital signal ADO[1:0] indicative of the degree of brightness of the environment as shown in Table 4.

The VSYNC counter 343 generates a signal VSCLK that determines the cycle of reflecting the A/D conversion result ADO[1:0] on the basis of the vertical sync signal VSYNC input from the outside and a 3-bit set value ABT[2:0] of the cycle setting register 345. The A/D conversion result processing circuit 342 determines the cycle of actually adjusting the gray scale voltage from the VSCLK signal and a 2-bit set value FWP[1:0] of the frequency setting register 346 and commonly outputs the A/D conversion result ADO[1:0] at a timing according to the cycle as an adjustment control signal SKA[1:0] to the control registers 313R, 313G, and 313B.

In the control register 313R for R, by using SKA[1:0] as a selection signal, the selector SEL1 selects one of the amplitude adjustment registers KA1R, KA2R, KA3R, and KA4R and the selector SEL2 selects one of the curve adjustment registers KC1R, KC2R, KC3R, and KC4R. According to the state of the start setting flag 347, the selector SEL3 at the post stage selects either the selected register or the inherent amplitude adjustment register KA0R for R, and the selector SEL4 at the post stage selects either the selected register or the curve adjustment register KC0R for R. Each of the selectors SEL3 and SEL4 inputs the value of the selected register to the gray scale voltage generation circuit 315R for R at the post stage. The control register 313G for G and the control register 313B for B operate similarly. The gray scale voltage generation circuit 315R outputs a gray scale voltage according to the inputs from the control register 313R for R. The start setting flag 347 may be one bit in a control register which is provided for a control circuit for controlling the whole IC.

Table 5 shows an example of the relation between a set value ABT[2:0] of the cycle setting register 345 and the sampling cycle of the signal VSCLK output from the VSYNC counter 343. The VSYNC counter 343 determines the cycle of sampling the signal PSVI in accordance with the set value ABT[2:0] of the cycle setting register 345, and outputs the signal VSCLK at the timing corresponding to the determined cycle.

TABLE 5

| Register | Sampling |
|---|---|
| value ABT[2:0] | cycle VSCLK |
| 000 | 1/fvsync |
| 001 | 2/fvsync |
| 010 | 4/fvsync |
| 011 | 8/fvsync |
| 100 | 16/fvsync |
| 101 | 32/fvsync |
| 110 | 64/fvsync |
| 111 | setting inhibited |

Table 6 shows the relation between a set value FWP[1:0] of the frequency setting register 346 and a condition (reflection frequency) for reflecting the A/D conversion result ADO[1:0] input to the A/D conversion result processing circuit 342 in FIG. 5 into the output SKA[1:0]. Concretely, the value of ADO[1:0] of the current cycle indicated by the signal VSCLK and the value of ADO[1:0] of the immediately preceding cycle indicated by VSCLK are compared with each other, thereby determining a reflection condition.

TABLE 6

| Register value | Condition of reflecting sampled A/D |
|---|---|
| FWP[1:0] | conversion result |
| 00 | Unconditioned (each time) |
| 01 | Coincidence of twice in succession |
| 10 | Coincidence of three times in succession |
| 11 | Coincidence of four times in succession |

As shown in Table 6, in the embodiment, when the set value FWP[1:0] of the frequency setting register 346 is 00, the value of the A/D conversion result ADO[1:0] is output as SKA[1:0] every VSCLK cycle. In the case where FWP[1:0]=01, when the values of ADO[1:0] in successive two VSCLK cycles coincide with each other, the value of ADO[1:0] is output as SKA[1:0]. In the case where FWP[1:0]=10, when the values of ADO[1:0] in successive three VSCLK cycles coincide with each other, the value of ADO[1:0] is output as SKA[1:0]. Further, in the case where FWP[1:0]=11, when the values of ADO[1:0] of four successive VSCLK cycles coincide with each other, the value of ADO[1:0] is output as SKA[1:0]. In such a manner, in the embodiment, by preliminarily determining the reflection condition of the light control circuit in accordance with the set vales of the registers 345 and 346, gamma characteristic adjustment according to a level change amount of the signal PSVI input from an external photosensor is performed in proper cycles.

Table 7 shows an amplitude adjustment register and a curve adjustment register selected by the output signal SKA[1:0] of the A/D conversion result processing circuit 342.

TABLE 7

| A/D conversion | | | | |
|---|---|---|---|---|
| result processing | Brightness | | | |
| circuit Output | of | | | |
| SKA[1:0] | environment | Corresponding registers | | Remarks |
| 00 | Darkest | Amplitude | KA1R[6:0] | For R |
| | environment | adjustment | KA1G[6:0] | For G |
| | | register | KA1B[6:0] | For B |
| | | Curve | KC1R[3:0] | For R |
| | | adjustment | KC1G[3:0] | For G |
| | | register | KC1B[3:0] | For B |
| 01 | Second | Amplitude | KA2R[6:0] | For R |
| | darkest | adjustment | KA2G[6:0] | For G |
| | environment | register | KA2B[6:0] | For B |
| | | Curve | KC2R[3:0] | For R |
| | | adjustment | KC2G[3:0] | For G |
| | | register | KC2B[3:0] | For B |
| 10 | Second | Amplitude | KA3R[6:0] | For R |
| | brightest | adjustment | KA3G[6:0] | For G |
| | environment | register | KA3B[6:0] | For B |
| | | Curve | KC3R[3:0] | For R |
| | | adjustment | KC3G[3:0] | For G |
| | | register | KC3B[3:0] | For B |
| 11 | Brightest | Amplitude | KA4R[6:0] | For R |
| | environment | adjustment | KA4G[6:0] | For G |
| | | register | KA4B[6:0] | For B |
| | | Curve | KC4R[3:0] | For R |
| | | adjustment | KC4G[3:0] | For G |
| | | register | KC4B[3:0] | For B |

As shown in Table 7, in the embodiment, in the case where SKA[1:0]=00 as the darkest environment, as the amplitude adjustment registers for R, G, and B, KA1R, KA1G, and KA1B are selected, respectively. As the curve adjustment registers for R, G, and B, KC1R, KC1G, and KC1B are selected, respectively. In the case of SKA[1:0]=01 indicative of the second darkest environment, as the amplitude adjustment registers, KA2R, KA2G, and KA2B are selected. As the curve adjustment registers for R, G, and B, KC2R, KC2G, and KC2B are selected, respectively. In the case of SKA[1:0]=10 indicative of the second brightest environment, as the amplitude adjustment registers, KA3R, KA3G, and KA3B are selected for R, G, and B, respectively. As the curve adjustment registers, KC3R, KC3G, and KC3B are selected for R, G, and B, respectively. In the case of SKA[1:0]=11 indicative of the brightest environment, as the amplitude adjustment registers, KA4R, KA4G, and KA4B are selected for R, G, and B, respectively. As the curve adjustment registers, KC4R, KC4G, and KC4B are selected for R, G, and B, respectively. By inputting the selected register values for R, G, and B to the gray scale voltage generation circuits 315R, 315G, and 315B, respectively, a desired gray scale voltage and a desired gamma curve are generated. In each of the registers, a value for generating a gray scale voltage corresponding to the degree of brightness is set.

As described above, in the display drive circuit for the organic EL panel of the embodiment, the brightness (darkness) of the environment is detected every predetermined cycle on the basis of the input signal PSVI from the external photosensor 100 and each of the gray scale voltages and the gamma curves for R, G, and B is adjusted. Thus, the higher picture quality display drive can be performed.

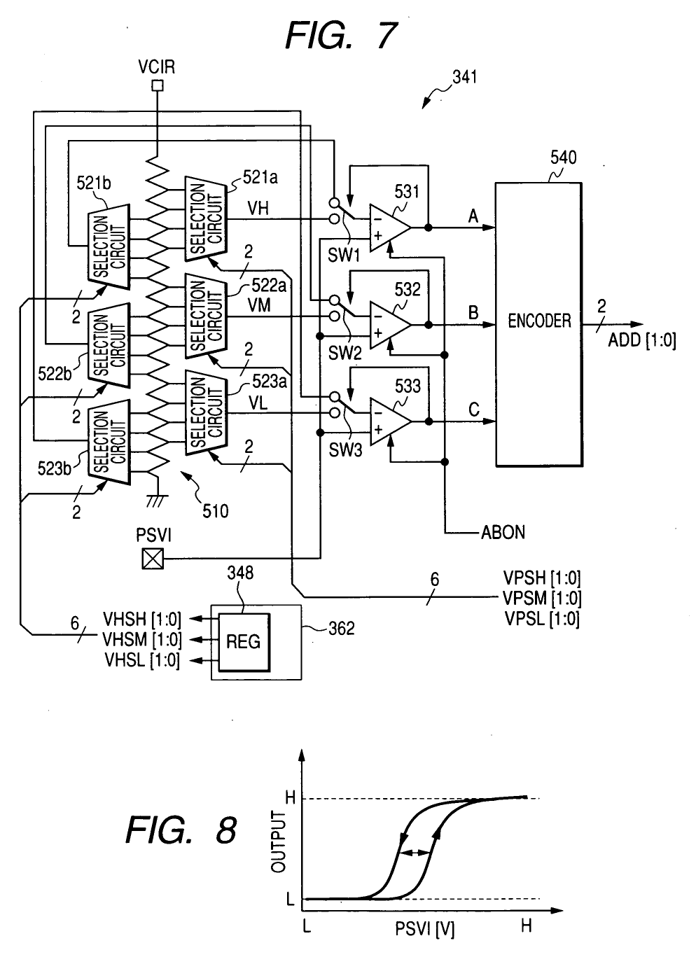

FIG. 7 shows another embodiment of the A/D converter 341.

The A/D converter 341 of the another embodiment has a hysteresis characteristic. Concretely, the A/D converter 341 has a set of selection circuits (selectors) 521a, 522a, and 523a for selecting proper voltages from voltages generated by the resistive divider 510 constructed by a ladder resistor. The A/D converter 341 also has another set of selection circuits (selectors) 521b, 522b, and 523b for selecting voltages slightly lower than the voltages selected by the selection circuits (selectors) 521a, 522a, and 523a.

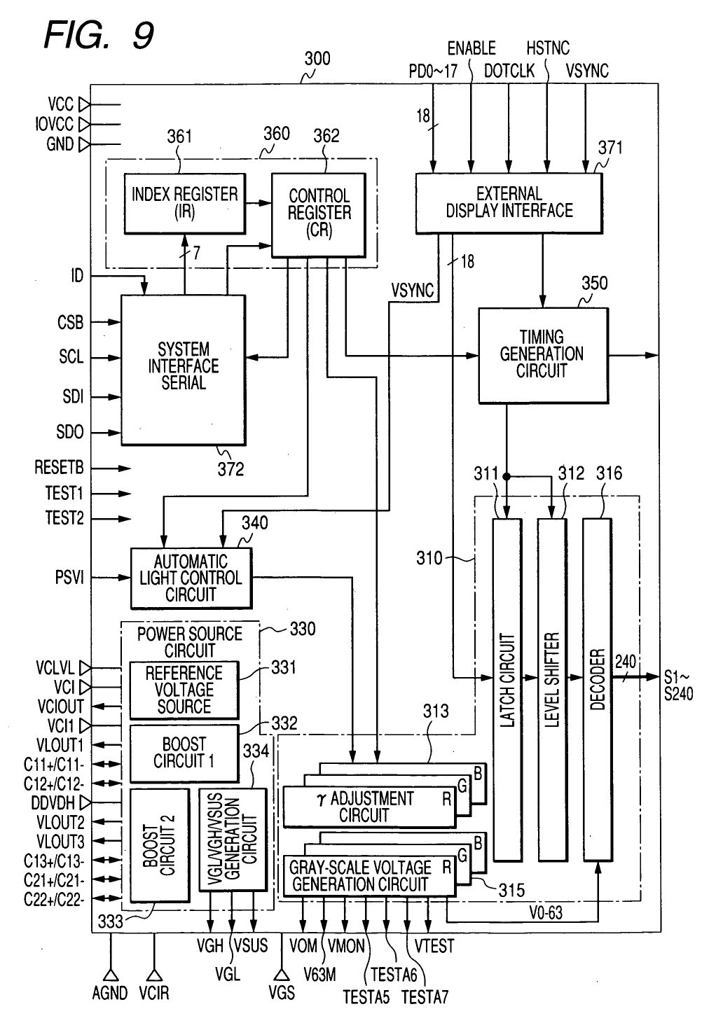

In addition, change-over switches SW1 to SW3 are provided, which switch between the voltages selected by the set of selection circuits (selectors) 521a, 522a, and 523a and the voltages selected by the another set of selection circuits (selectors) 521b, 522b, and 523b and applying the voltages switched to the inversion input terminals of the comparators 531, 532, and 533. The input signal PSVI from the external photosensor 100 is supplied to the non-inversion input terminals (+) of the comparators 531, 532, and 533. Each of the selection circuits (selectors) 521b, 522b, and 523b can select one of, for example, four voltages. The selection circuits (selectors) 521b, 522b, and 523b select desired voltages in accordance with the set values VHSH[1:0], VHSM[1:0], and VHSL[1:0] of a hysteresis setting register 348 and supply the selected voltages to the comparators 531, 532, and 533. The hysteresis setting register 348 is provided for a control register (CR) 362 in FIG. 9 which will be described later.

When the outputs of the comparators 531, 532, and 533 change to the high level from the low level, the change-over switches SW1 to SW3 switch voltages applied to the inversion input terminals to the lower voltages selected by the selection circuits (selectors) 521b, 522b, and 523b. The change-over switches SW1 to SW3 are controlled to switch, as voltages applied to the inversion input terminals, to higher voltages selected by the selection circuits (selectors) 521a, 522a, and 523a when the outputs of the comparators 531, 532, and 533 change from the high level to the low level. With such a configuration, the A/D converter 341 of the embodiment has the hysteresis characteristic as shown in FIG. 8 for the input signal PSVI from the photosensor 100. As a result, reaction to subtle fluctuations in the brightness of the environment, that is, disturbance noise is suppressed, so that frequent changes in the luminance of the organic EL panel causing deterioration in viewability can be avoided.

In place of providing two sets of selection circuits (selectors) for selecting voltages generated by the resistive divider 510, comparators having a hysteresis characteristic may be used as the comparators 531, 532, and 533. A comparator having a hysteresis characteristic is known and can be used in the embodiment, so that a concrete example will not be described.

However, when a hysteresis is given by switching a reference voltage of the comparator as in the embodiment, according to a device using a driver IC to which the embodiment is applied, the degree (width) of the hysteresis can be adjusted. Consequently, display optimum to a device can be performed and, also in use, the hysteresis can be dynamically changed, for example, according to the strength of a signal from the photosensor 100. There is consequently an advantage such that the degree (width) of the hysteresis is changed between the case of using the device indoor and the case of using the device outdoor, so that activation does not change so frequently in accordance with the environments.

Next, the configuration of the whole organic EL panel driver IC having therein the signal line drive circuit 310 shown in FIG. 1 will be described with reference to FIG. 9. In FIG. 9, the same reference numerals are designated to the same circuits as those shown in FIG. 1 and their description will not be repeated.

The organic EL panel driver IC 300 of the embodiment has a controller 360 for controlling the whole inside of a chip on the basis of a command from an external microprocessor, a microcomputer (hereinbelow, described as CPU), or the like. The driver IC 300 also includes an external display interface 371 that receives motion picture data, horizontal/vertical sync signals HSYNC and VSYNC, sync signals such as a dot clock DOTCLK, and an external control signal such as an enable signal mainly from an application processor or the like via a not-shown display data bus. The driver IC 300 further includes a system interface 372 for transmitting/receiving data such as an instruction code to/from a CPU or the like via a not-shown system bus.

The timing control circuit 350 for generating timing signals which give operation timings of various circuits in the chip generates a timing signal on the basis of a sync signal received from the outside via the external display interface 371. The motion picture data from the application processor is supplied synchronously with the dot clock signal DOTCLK. The system interface 372 inputs/outputs data in series synchronously with a clock SCL supplied from a CPU or the like under condition that a chip select signal CSB is set to a valid level. To the latch circuit 311 of the signal line drive circuit 310, display data is transferred from the external display interface 371 in unit of 18 bits or 6 bits.

The controller 360 has registers such as the control register (CR) 362 for controlling an operation state of the whole chip such as an operation mode of the driver IC 300, and an index register (IR) 361 that stores index information for referring to the control register 362. The control register (CR) 362 includes registers such as 313R, 313G, and 313B shown in FIGS. 1 and 4 and 344, 345, KA0R to KA4R and KC0R to KC4R shown in FIG. 5. A control system is employed in which when an external CPU or the like designates an instruction to be executed by writing the index register 362, the controller 360 generates and outputs a control signal corresponding to the designated instruction. As the control system of the controller 360, a system of receiving a command code from an external CPU or the like, decoding the command, and generating a control signal may be also employed.

The power source circuit 330 includes boost circuits 332 and 333 for generating a voltage higher than the power supply voltage Vcc by boosting the power supply voltage Vcc supplied from a reference voltage generation circuit 331 or from the outside and a scan line driving voltage generation circuit 334 for generating voltages VGH, VGL, and VSUS necessary for the scan line drive circuit 320. The power source circuit 330 generates voltages necessary for the gray scale voltage generation circuit 315 for generating a gray scale voltage to drive the organic EL panel and the scan line drive circuit 320 on the outside of the chip. Although not limited, the signal line drive circuit 310 of the drive IC 300 of the embodiment generates and outputs voltages S1 to S240 which are applied to 240 signal lines of the organic EL panel.

The signals input to the driver IC 300 of the embodiment include, in addition to the above, the signal PSVI from the photosensor, a reset signal RESET for setting the inside of the chip to an initial state, and test signals TEST1 and TEST2 for testing an internal circuit. The chip of the driver IC 300 in the embodiment includes not only input/output terminals of the signals but also terminals to which capacitive elements used for the boost circuits 332 and 333 are connected and terminals for outputting voltages generated by the boost circuits 332 and 333 and the gray scale voltage generation circuit 315. Since those terminals are not directly related to the present invention, they will not be described.

Although the present invention achieved by the inventors of the present invention has been described above on the basis of the embodiment, the invention is not limited to the foregoing embodiment but may be variously changed without departing from the gist of the invention. For example, the amplitude adjustment register and the curve adjustment register for holding values for adjusting the gamma characteristic are provided in the embodiment. In place of the registers, setting means (ROM) constructed by nonvolatile memory elements may be used. In this case, when any of amplitude adjustment values in the ROM is selected, a curve adjustment value optimum to the amplitude adjustment value may be automatically read from the ROM.

Although the organic EL panel driver IC 300 of the embodiment uses the scan line drive circuit 320 for driving a scan line of the organic EL panel 200 as a circuit on the outside of the IC, the organic EL panel driver IC 300 may be also constructed as a driver IC having therein the scan line drive circuit 320. Although a detection signal of a photosensor is used as it is as a signal indicative of the brightness of the environment in the embodiment, a signal supplied from another circuit may be used. That is, the invention is not limited to a signal from the photosensor but any signal may be used as long as the signal indicates brightness of the environment.

Although the present invention achieved by the inventors herein has been described with respect to the driver that drives an organic EL panel in the field of utilization as the background of the invention, the invention is not limited to the driver but may be applied to a driver that drives a light emitting panel other than the organic EL panel.

1. A semiconductor integrated circuit for display driving, that generates and outputs a drive voltage to be applied to a signal line of a light emitting display panel in accordance with display data and can change a gray scale voltage to be applied to the drive voltage in response to an input signal according to brightness of the environment, comprising:
a storing circuit that stores a plurality of set values for specifying a maximum value and a minimum value of the gray scale voltage;
a control circuit that outputs a signal designating any of the set values in the storing circuit in accordance with the input signal;
a selection circuit that selects a set value corresponding to the input signal from the storing circuit in accordance with an output of the control circuit; and
a gray scale voltage generation circuit that generates a gray scale voltage applied to the drive voltage in response to reception of an output of the selection circuit.

2. A semiconductor integrated circuit for display driving according to claim 1, further comprising a second storing circuit that stores a plurality of set values for specifying a change characteristic of the gray scale voltage.

3. A semiconductor integrated circuit for display driving according to claim 2, wherein the storing circuit and the second storing circuit are registers capable of rewriting a set value stored.

4. A semiconductor integrated circuit for display driving according to claim 1, wherein the gray scale voltage generation circuit is provided for each of three primary colors of red, blue, and green, the drive voltages are generated separately as signals corresponding to the three primary colors, and the set value stored in the storing circuit is stored in correspondence with each of the three primary colors.

5. A semiconductor integrated circuit for display driving according to claim 4, wherein the control circuit has an A/D converter for converting the input signal to a digital signal, and a set value selected from the storing circuit by the selection circuit is changed according to an output of the A/D converter.

6. A semiconductor integrated circuit for display driving according to claim 5, wherein the control circuit has a validating control circuit for controlling validity/invalidity of an output of the A/D converter and, when the validating control circuit is made valid, a set value selected from the storing circuit by the selection circuit is changed.

7. A semiconductor integrated circuit for display driving according to claim 6, wherein the control circuit has a register for storing a set value that designates frequency of validating an output of the A/D converter, and the validating control circuit controls validity/invalidity of an output of the A/D converter in accordance with a set value of the register.

8. A semiconductor integrated circuit for display driving according to claim 7, wherein the A/D converter is constructed to have a hysteresis characteristic for an input.

9. A semiconductor integrated circuit for display driving according to claim 8, wherein the A/D converter has a plurality of comparators for comparing the input signal with a predetermined reference voltage, and has a hysteresis characteristic by switching the reference voltage in accordance with a change in the output of each of the comparators.

10. An electronic device comprising:
a semiconductor integrated circuit for display driving according to claim 1;
a light emitting display driven by the semiconductor integrated circuit for display driving; and
a light amount detector for detecting brightness of the environment of the device,
wherein a detection signal of the light amount detector is input as the input signal to the semiconductor integrated circuit for display driving.

11. An electronic device comprising:
a semiconductor integrated circuit for display driving according to claim 2;
a light emitting display driven by the semiconductor integrated circuit for display driving; and
a light amount detector for detecting brightness of the environment of the device,
wherein a detection signal of the light amount detector is input as the input signal to the semiconductor integrated circuit for display driving.

12. An electronic device comprising:
a semiconductor integrated circuit for display driving according to claim 3;
a light emitting display driven by the semiconductor integrated circuit for display driving; and
a light amount detector for detecting brightness of the environment of the device,
wherein a detection signal of the light amount detector is input as the input signal to the semiconductor integrated circuit for display driving.

13. An electronic device comprising:
a semiconductor integrated circuit for display driving according to claim 4;
a light emitting display driven by the semiconductor integrated circuit for display driving; and
a light amount detector for detecting brightness of the environment of the device,
wherein a detection signal of the light amount detector is input as the input signal to the semiconductor integrated circuit for display driving.

14. An electronic device comprising:
a semiconductor integrated circuit for display driving according to claim 5;
a light emitting display driven by the semiconductor integrated circuit for display driving; and
a light amount detector for detecting brightness of the environment of the device,
wherein a detection signal of the light amount detector is input as the input signal to the semiconductor integrated circuit for display driving.

15. An electronic device comprising:
a semiconductor integrated circuit for display driving according to claim 6;
a light emitting display driven by the semiconductor integrated circuit for display driving; and
a light amount detector for detecting brightness of the environment of the device,
wherein a detection signal of the light amount detector is input as the input signal to the semiconductor integrated circuit for display driving.

16. An electronic device comprising:
a semiconductor integrated circuit for display driving according to claim 7;
a light emitting display driven by the semiconductor integrated circuit for display driving; and
a light amount detector for detecting brightness of the environment of the device,
wherein a detection signal of the light amount detector is input as the input signal to the semiconductor integrated circuit for display driving.

17. An electronic device comprising:
a semiconductor integrated circuit for display driving according to claim 8;
a light emitting display driven by the semiconductor integrated circuit for display driving; and
a light amount detector for detecting brightness of the environment of the device,
wherein a detection signal of the light amount detector is input as the input signal to the semiconductor integrated circuit for display driving.

18. An electronic device comprising:
a semiconductor integrated circuit for display driving according to claim 9;
a light emitting display driven by the semiconductor integrated circuit for display driving; and
a light amount detector for detecting brightness of the environment of the device,
wherein a detection signal of the light amount detector is input as the input signal to the semiconductor integrated circuit for display driving.
